(19) United States
(12) Patent Application Publication
(10) Pub. No.: US 2024/0270098 A1
(43) Pub. Date: Aug. 15, 2024

(54) ELECTRIC VEHICLE CHARGING STATION PARKING BLOCK

(71) Applicant: Dean Solon, Gallatin, TN (US)

(72) Inventor: Dean Solon, Gallatin, TN (US)

(21) Appl. No.: 18/441,642

(22) Filed: Feb. 14, 2024

Related U.S. Application Data
(60) Provisional application No. 63/485,148, filed on Feb. 15, 2023.

(51) Int. Cl. B60L 53/18; E01F 13/00; H02G 9/04

(52) U.S. Cl. CPC B60L 53/18; E01F 13/00; H02G 9/04

(57) ABSTRACT

An electric vehicle charging station parking block. In one aspect, the parking block includes a top surface and a bottom surface. The bottom surface is configured to be closer to the ground than the top surface when the parking block is in an installed state. The parking block has a cord channel defined at a location within the parking block that is between the top surface and the bottom surface. The cord channel is a void configured to accept a cord that connects an electric vehicle (EV) charger to an EV charging port configured to physically connect to an EV.

### CLAIM OF PRIORITY

This application claims priority to U.S. Provisional Application Ser. No. 63/485,148, filed on Feb. 15, 2023, the entire contents of which are hereby incorporated by reference.

### BACKGROUND

This specification relates to improvements to parking blocks for charging stations, such as electronic vehicle (EV) charging stations. An electric vehicle charging station is a device that provides electric energy to recharge the battery of an electric vehicle. A charging port physically connects to the car and enables power to flow from the EV charging station to the car by way of a cord that connects the charging port to the charger of the EV charging station.

### SUMMARY

In general, one innovative aspect of the subject matter described in this specification can be embodied in a parking block including a top surface; and a bottom surface. The bottom surface is configured to be closer to the ground than the top surface when the parking block is in an installed state. The parking block has a cord channel defined at a location within the parking block that is between the top surface and the bottom surface. The cord channel is a void configured to accept a cord that connects an electric vehicle (EV) charger to an EV charging port configured to physically connect to an EV.

These and other embodiments can each optionally include one or more of the following features. The cord channel can be accessible through the bottom surface of the parking block.

The cord channel can be accessible from an exterior surface of the parking block. The exterior surface can be a side surface, an end surface, a top surface, a bottom surface or another exterior surface.

The cord channel can be accessible from two exterior surfaces of the parking block.

The two exterior surfaces can include a first exterior surface and a second exterior surface; and the cord channel can be defined in, and accessible from, each of the first exterior surface and the second exterior surface. The cord channel can be a continuous void that extends between and through the first exterior surface and the second exterior surface.

The first exterior surface and the second exterior surface can meet to form a corner of the parking block.

The first exterior surface can be an end surface of the parking block having a smaller surface area than the second exterior surface. The cord channel can be formed through the second exterior surface in a middle one-third section of the second exterior surface.

The first exterior surface can be an end surface of the parking block having a smaller surface area than the second exterior surface. The cord channel can be formed through the second exterior surface outside of a middle one-third section of the second exterior surface.

The first exterior surface can be on an opposite side of the bottom surface than the second exterior surface. A first distance from an end surface of the parking block at which the cord channel passes through a first plane of the first exterior surface can differ from a second distance from the end surface of the parking block at which the cord channel passes through a plane of the second exterior surface.

A perimeter of the cord channel can be angled. The perimeter of the cord channel can be rectangular.

A perimeter of the cord channel can be arced or rounded.

The parking block can include electrical conductors routed through the cord channel; and a wire harness connector located at one or more ends of the cord channel.

The parking block can include a connection to a second parking block. The connection to the second parking block can have a length that enables the parking block to be aligned with the second parking block in a stacked formation.

The electrical connectors can be embedded in the parking block prior to hardening of the parking block. The cord channel can be defined by the electrical conductors as the parking block hardens.

The parking block can be one or more of concrete, plastic, or rubber. The cord channel can be defined by the electrical conductors that are located within a perimeter of the parking block as the concrete, plastic, or rubber cures.

The wire harness connector can be located at one or more of an entry port or an exit port of the cord channel of the parking block.

The wire harness connector can be located at both of the entry port and the exit port of the cord channel of the parking block.

The connection to the parking block can be a pre-fabricated connection between the parking block and the second parking block in a hardwired manner.

The connection to the second parking block can be connectorized in a manner that enables the connection to the second parking block to be made after the parking block is placed into an installation location.

Particular embodiments of the subject matter described in this specification can be implemented so as to realize one or more of the following advantages. For example, the subject matter described herein can prevent cords of EV charging stations (also referred to as charging stations for brevity) from being strewn across the ground, which reduces tripping hazards for users of charging stations, as well as pedestrians walking in the vicinity of the charging stations. For example, a new parking block (also known as a car stop) configured to route the cord through the parking block can be used to eliminate trip hazards that would be caused by leaving the cord exposed (e.g., laying on the ground). Because parking blocks are already used to mark the edge of a parking space and prevent cars from hitting the charging station (or other objects), routing the cord through the specially configured parking block eliminates any additional tripping hazards that would have otherwise been caused by an exposed cord.

A series of electrically interconnected parking blocks can be used to simplify the installation of parking blocks that reduce trip hazards. For example, the parking blocks can be manufactured with conductors that are routed through and between the parking blocks. This series of multiple interconnected parking blocks can be transported to the installation location in a “stacked” orientation, and then simply unstacked into the appropriate position. Because the parking blocks are already electrically interconnected, the parking blocks simply need to be appropriately spaced and secured. No electrical work needs to be performed. Rather, one of the parking blocks can be connected to an existing power source (e.g., plugged in to an EV charging station), and power will be available at each of the interconnected parking blocks.

As discussed in more detail below, the solutions described herein can also be configured using lower profile (e.g., flattened) cords that connect the charger of the charging station to the charging port. These lower profile cords reduce the height of any cords that are placed on the ground relative to the high profile (e.g., round) cords that are conventionally used.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an illustration of a vehicle connected to an EV charging station.

FIGS. 2A-2K are illustrations showing different configurations of a cord channel formed in a parking block.

FIGS. 3A-3D are illustrations depicting different configurations of cord channels.

FIGS. 4A-4C are illustrations of interconnected parking blocks.

Like reference numbers and designations in the various drawings indicate like elements.

### DETAILED DESCRIPTION

The present specification describes systems and methods for implementing a parking block that reduces trip hazards caused by cords of an electric vehicle (EV) charging station. As described in more detail below, a specially configured parking block can be used to hide a charging cord connecting the charger of the charging station to the charging port (e.g., the plug that connects to the EV). For example, the parking block can be formed to have a cord channel (e.g., a void) through which the charging cord can be routed. By routing the charging cord through the cord channel of the parking block, the cord is no longer exposed, such that the cord is no longer a trip hazard. In some implementations, the cord channel can be round, or otherwise have an arced shape so that round charging cables can be routed through the cord channel. In some implementations, the cord channel is rectangular to accept flat (e.g., rectangular) cables, such as ribbon cables. Using flat cables can lower the profile of the charging cable so that any exposed cable (e.g., between the charging station and the parking block or between the parking block and the charging port) is less of a trip hazard than the round charging cables currently being used.

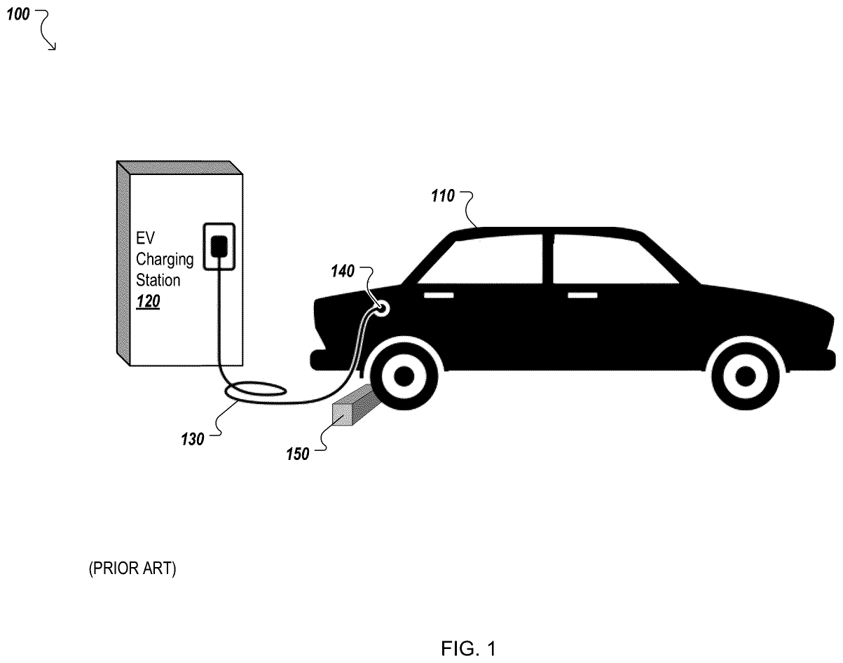

FIG. 1 is an illustration 100 of an electronic vehicle (EV) 110 connected to an EV charging station 120. As shown, the charging station 120 has a charging cord 130 that connects the charger of the charging station 120 to a charging port 140 of the charging station 120, which physically connects the charging station 120 to the EV 110. Usually, the charging cord 130 is very long (e.g., at least the length of the vehicles intended to be charged), so that the charging port 140 at the end of the charging cord 130 can reach a charging receptacle of the car that receives the charging port 140 of the charging station 120. For example, while the EV 110 is shown with the charging port 140 connected at an end of the EV 110 that is closest to the charging station 120, but the charging cord 130 is generally long enough to reach the opposite end of the EV 110 so that the charging port 140 can still be connected to the EV 110 if its charging receptacle was located at the other end of the EV 110, or the EV 110 pulled into the parking space in the opposite direction. Furthermore, it is common to use a parking block 150 to maintain a safe distance between the EV 110 and the charging station 120, which increases the length of the charging cord 130 that is needed to ensure the charging port 140 can reach the EV 110. This often results in portions of the charging cord 130 being placed on the ground, either strewn about, or piled up, which creates a significant tripping hazard to people walking, or otherwise moving about, near the exposed charging cord 130.

A parking block is a device generally used to indicate the proper parking spot for a vehicle and maintain a safe distance between the vehicle and other objects, such as walls, buildings, walkways and charging stations. The parking block 150 can be made of concrete, plastic, rubber, or another appropriate rigid material, and is placed along the edge of a parking space to physically prevent a vehicle from rolling over the curb or into another space. The parking block 150 can be secured to the ground using anchor bolts. For example, the parking block 150 can be drilled and then bolted to the surface of the pavement or concrete using concrete anchors. The anchors often include a threaded rod, typically made of steel, that is embedded into the concrete, with a nut and washer on the end to hold the block in place. In some cases, adhesive may also be used in conjunction with the anchor bolts to provide added stability and security. Once installed, the parking block 150 is generally not movable, and the charging cord 130 is often laid over the parking block 150 when the charging port 140 is attached to the EV 110, which increases the trip hazard of the charging cord 130 because it is now elevated off the ground, rather than laying flat.

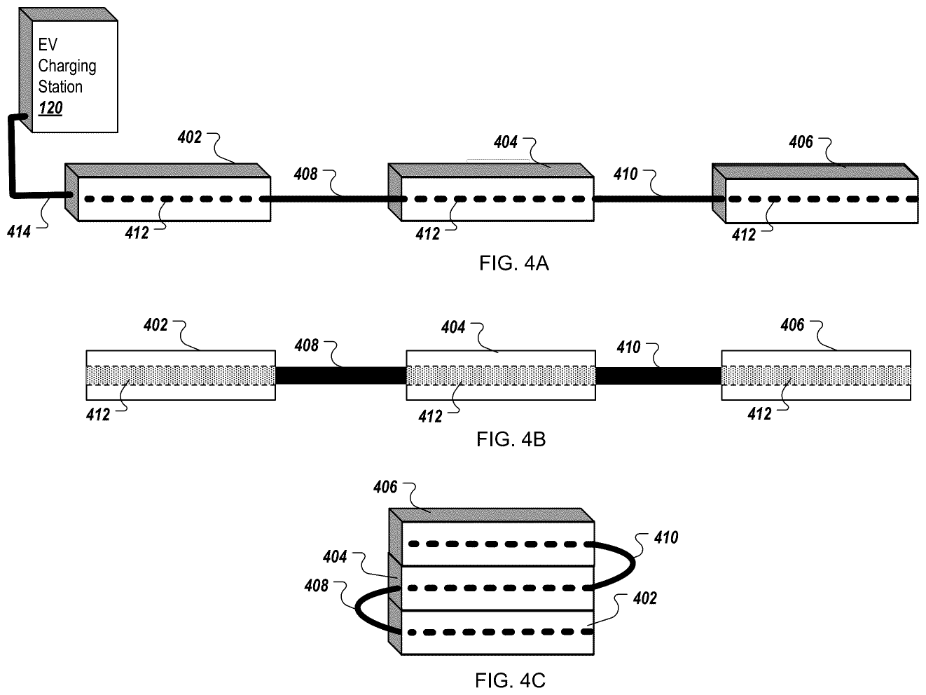

The trip hazard caused by charging cords that are laying on the ground and/or elevated off the ground by parking blocks can be reduced or eliminated by using specially configured parking blocks through which the charging cords can be routed. For example, as discussed more below, a parking block can have a cord channel created through a body of the parking block so that the charging cord can pass through, and be obscured by, the parking block. The cord channel can take many different forms, and pass-through different portions of the parking block depending on the location/arrangement of the charging station, among other factors. Furthermore, as discussed in detail with reference to FIGS. 4A-4C, a set of multiple parking blocks can be manufactured as a series of electrically connected parking blocks that are interconnected by a set of conductors (e.g., wires or charging cords). These set of conductors can be flexible so that the parking blocks can be arranged in a “stacked” configuration for transport, and then unstacked/unfolded at the desired installation location in a ready for use fashion.

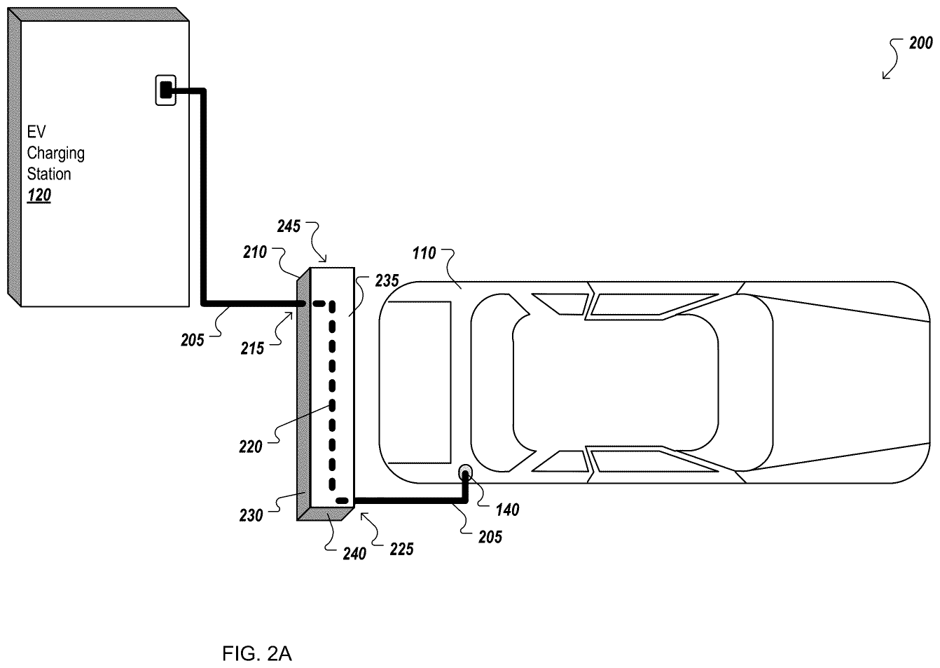

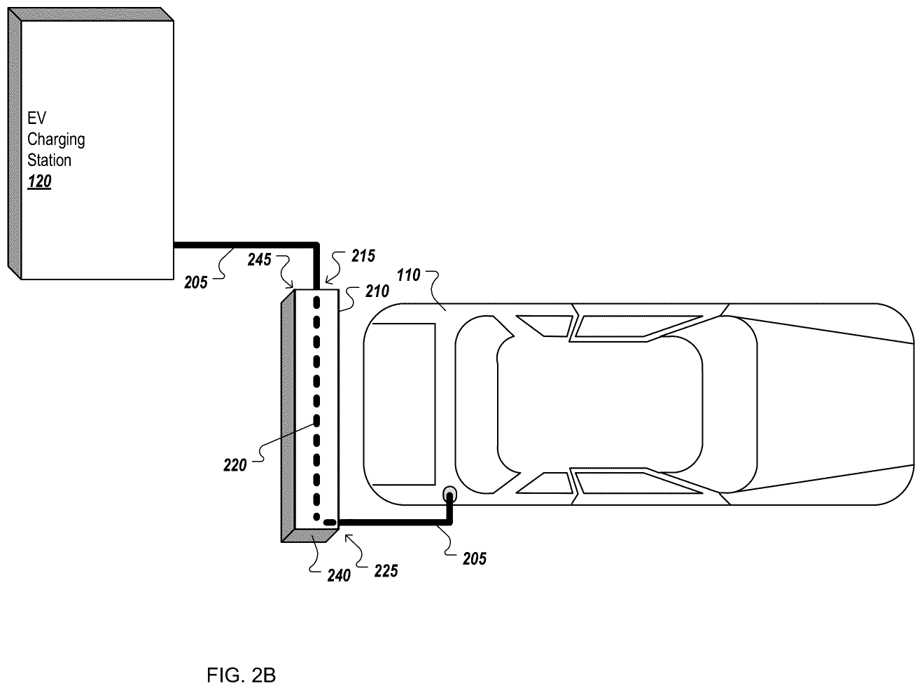

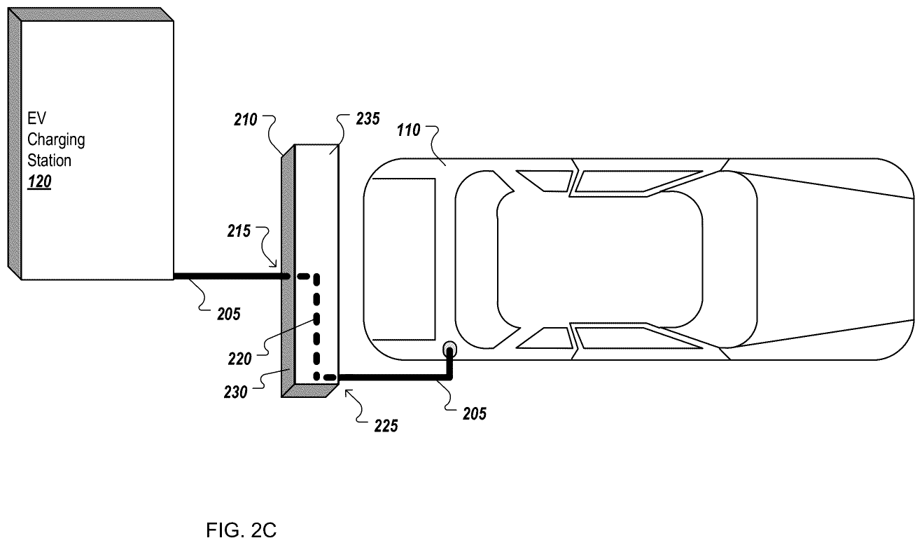

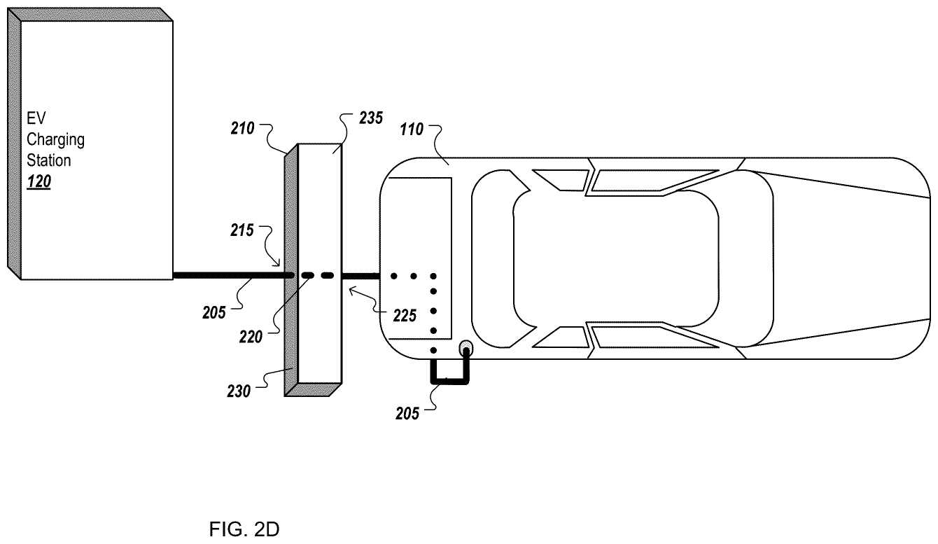

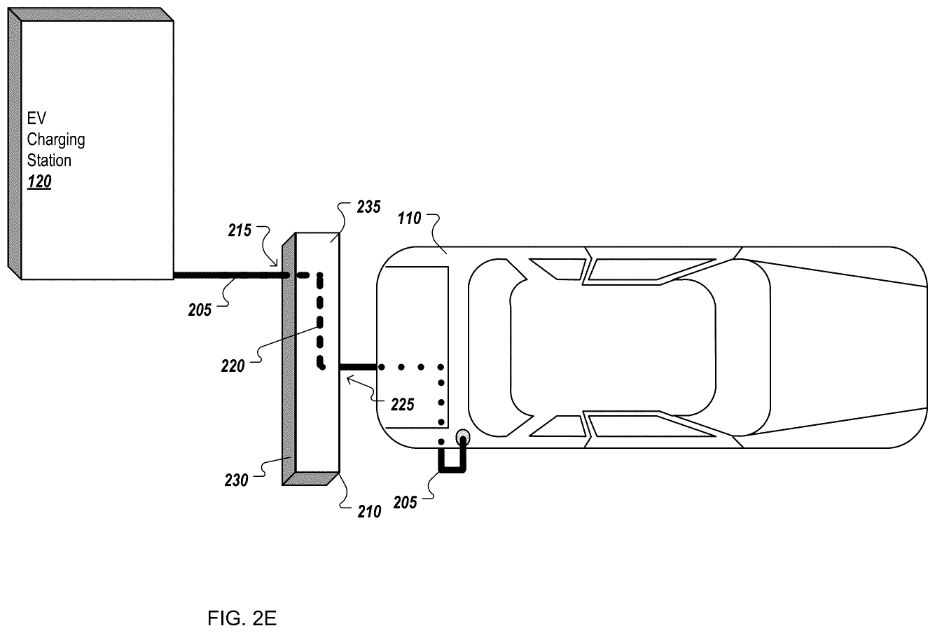

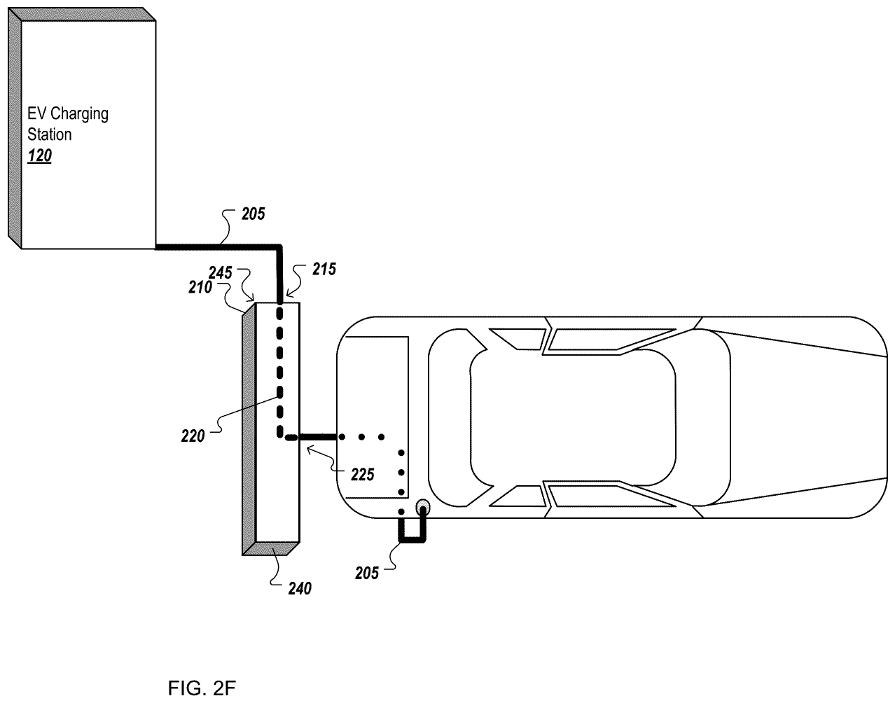

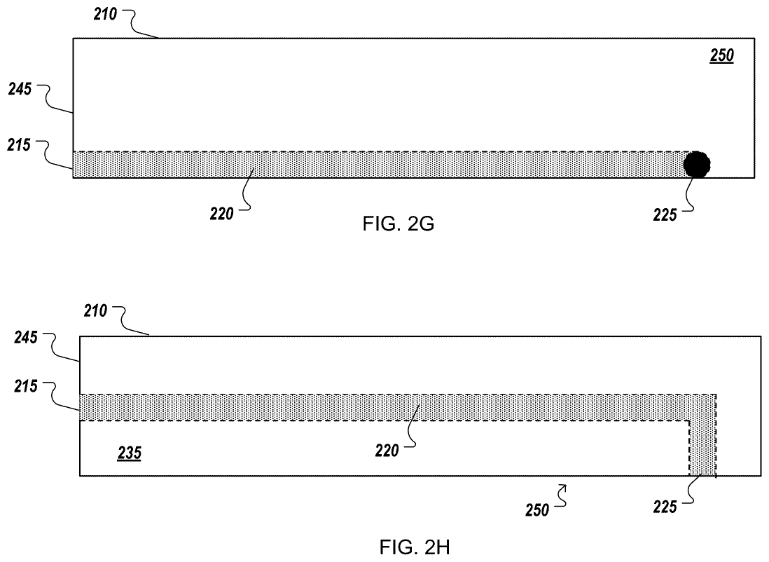

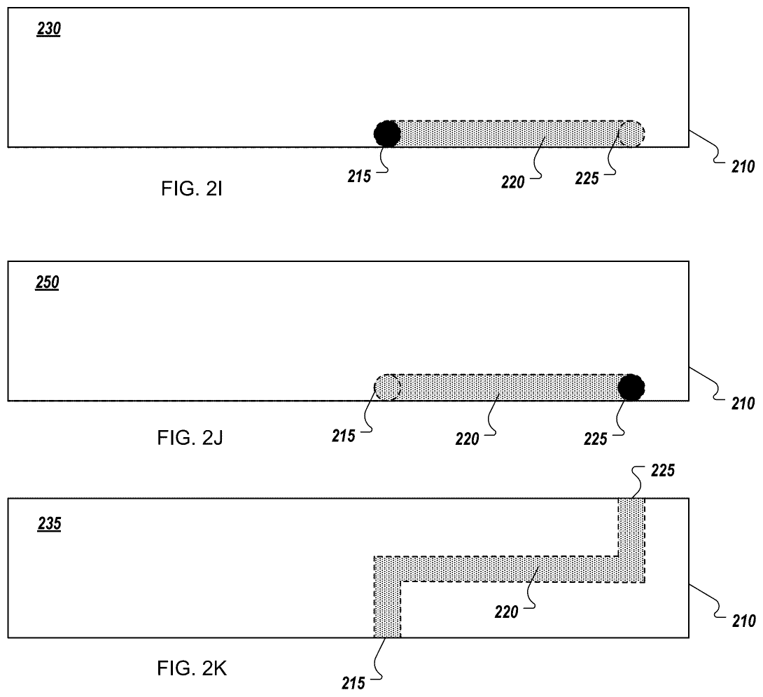

FIG. 2A is an illustration 200 of a charging cord 205 routed through a parking block 210. As shown, the charging cord 205 connects the charging station 120 to the charging port, which is physically connected to the EV 110. The charging cord 205 enters the parking block 210 at an entry port 215, is routed through a cord channel 220 that is defined in a body of the parking block 210 and exits the parking block 210 at an exit port 225. The parking block 210 of FIG. 2A is configured with the entry port 215 defined (e.g., created) in a first side surface 230 of the parking block 210, and the exit port 225 is defined in a second side surface (not visible) that is on an opposite side of the parking block 210 than the first side surface 230.

As used herein, a side surface of a parking block refers to a face of the parking block that is (i) between a top surface and a bottom surface of the parking block, and (ii) has a larger surface area than an end of the parking block that is between the side surface and an opposite side surface that is on an opposite side of the top surface and bottom surface. For example, as shown in FIG. 2A, the first side surface 230 is located (i) between the top surface 235 and the bottom surface (not visible) of the parking block 210 and (ii) has a larger surface area than the side 240 that is between the first side surface 230 and the second side surface (not visible) that is on the opposite side of the top surface and the bottom surface relative to the first side surface. Exterior surfaces of a parking block include side surfaces (e.g., 230), end surfaces (e.g., 240), the top surface (e.g., 235), and the bottom surface.

The top surface 235 of the parking block is generally configured to be further from the ground when the parking block 210 is installed (e.g., in an installed state), while the bottom surface of the parking block 210 is configured to be closer to the ground (e.g., in contact with the ground or one or more materials that are in between the parking block 210 and the ground) when the parking block 210 is installed (e.g., in an installed state). In some implementations, the parking block 210 is considered to be in an installed state when it is bolted, glued, or otherwise secured to the ground (or a surface between the ground and the parking block 210).

As mentioned above, the cord channel 220 is defined in the body of the parking block 210. In other words, the cord channel 220 is created at a location within the parking block that is between the top surface 235 and the bottom surface (inclusive). In some implementations, the cord channel can be defined by creating a void in the material of the parking block. The void can be configured (e.g., sized, and shaped) to accept the charging cord 205 that connects the EV charging station 120 to the EV 110 (e.g., by way of a charging port).

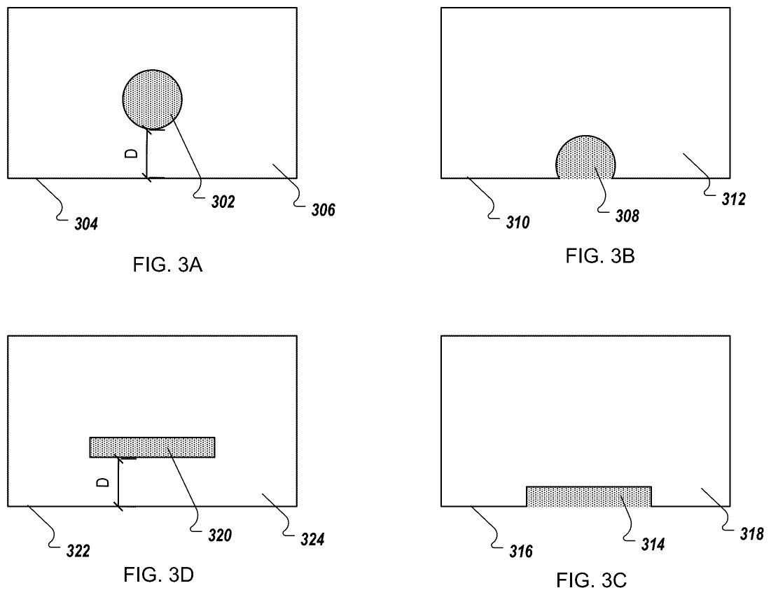

As shown in FIGS. 3A-3D, which are illustrations depicting different configurations of cord channels, the void defining the cord channel can be created in different ways (e.g., different geometric shapes or locations), such that the cord channel can be accessed in different ways. For example, as shown in FIG. 3A, the cord channel 302 is created as a round void that is formed at a specified distance (D) from the bottom surface 304 of the parking block 306. When configured in this manner, the cord channel is accessible from/through a side surface or end surface of the parking block but is not accessible from/through the bottom surface 304 of the parking block 306. The round shape of the cord channel 302 configures the parking block for use with round cords (e.g., EV charging cords or other conductors). In other words, the cord channel 302 is configured to accept round charging cords based on the perimeter of the cord channel being arced/rounded.

FIG. 3B shows another configuration of a cord channel 308. In this configuration, the cord channel is accessible through the bottom surface 310 of the parking block 312, and again configured to accept round cords, such as round charging cords. The cord channel 308 is accessible through the bottom surface 310 because the void defining the cord channel 308 removes a portion of the bottom surface 310, such that a cord can be inserted into the parking block 312 through the opening in the bottom surface 310. The round shape of the void configures the cord channel 308 for use with round conductors.

FIG. 3C shows another configuration of a cord channel 314 that is accessible through a bottom surface 316 of a parking block 318 because a cord (e.g., charging cord) can be inserted into the cord channel 314 from the bottom of the parking block 318. This cord channel 314 is rectangular in shape thereby configuring it to accept flat (e.g., rectangular) cords, such as ribbon cables. Using flat cords reduces the profile (e.g., height) of the cords, which reduces the trip hazard relative to round cords having a similar electrical rating because the metal required to achieve a particular electrical rating is spread over a wider area, which reduces the height of the cord.

FIG. 3D shows the cord channel 320 being created at a distance D from the bottom surface 322 of the parking block 324. As shown, the cord channel is accessible from/through an exterior surface (e.g., a side surface or end surface) of the parking block 324 but is not accessible from/through the bottom surface 322 of the parking block 324. The angled/rectangular shape of the cord channel 320 perimeter configures the parking block for use with flat/rectangular cords (e.g., EV charging cords or other conductors), such as ribbon cables. In other words, the cord channel 320 is configured to accept flat/rectangular charging cords.

Returning to the discussion of FIG. 2A, as previously described, the cord channel 220 is accessible from two exterior surfaces of the parking block 210, the first side 230 and the second side. The entry port 215 is created/formed in, and accessible from, the first side 230, and in this particular configuration, the entry port 215 is formed in a side ⅓ of the parking block 210. To illustrate, assume that the parking block 210 is delineated into equal ⅓ sections. Once delineated, the location of the entry port 215 of the cord channel 220 is located outside of the middle ⅓ section of the parking block 210, such that the entry port 215 is necessarily located in one of the ⅓ side sections of the parking block 210. As such, the cord channel is formed through the side surface at a location that is outside of the middle ⅓ section of the first side 230. Of course, cord channel 220, as well as the rest of the cord channels discussed herein, can be formed to be accessible from the bottom surface of the parking block 210, or it can be formed at a specified distance from the bottom surface and/or top surface 235 of the parking block 210.

The cord channel 220 is configured to route the charging cord 205 from the entry port 215, which is near one end 245 of the parking block 210, to the exit port 225, which is defined in the second side and closer to the opposite end 240 of the parking block 210 than the entry port 215. As such, a first distance from an end surface of the parking block at which the cord channel 220 passes through a plane defined by the first side 230 (e.g., at the entry port 215) differs from the distance from the end surface at which the cord channel passed through another plane defined by the second side (e.g., at the exit port 225). In other words, the cord 205 enters the entry port 215 at a location that is offset (relative to the end) from the exit port 225 where the cord 205 exits the parking block.

In the particular configuration shown, the exit port 225 of the cord channel 220 is formed in the second side at a location that is outside of the middle ⅓ section of the parking block 210. As such, the cord channel is defined in and accessible from each of two exterior surfaces (e.g., the first side 230 and the second side), and is configured as a continuous void that extends between and through each of the two exterior surfaces. This enables the charging cord 205 to be routed through the parking block 210, thereby reducing the trip hazard posed by the charging cord 205 by housing a portion of the charging cord 205 that would normally be laying on the ground exposed. Configuring the cord channel in the manner shown in FIG. 2A, the charging cord 205 can be safely routed through the parking block 210 to a location that is closer to a charging port of the EV 110. Other configurations can also be used depending on the arrangement of items and/or the target application. Some of these configurations are described with reference to FIGS. 2B-2K.

FIG. 2B shows another configuration of the cord channel 220. In this configuration, the cord channel 220 still passes through, and is accessible from two exterior surfaces of the parking block 210, but rather than being defined in two opposite sides of the parking block 210, the cord channel 220 is defined in, and accessible from, the end 245 and the second side (not visible). For example, the entry port 215 is located in the end 245, and the exit port 225 is in the same section (e.g., outside of the middle ⅓ section) of the parking block 210, as discussed above with reference to FIG. 2A. The entry port 215 and the exit port 225 are connected by a continuous void defining the cord channel 220. This configuration causes the portion of the cord that emits from the exit port 225 to be offset from the center of the parking block 210.

In this configuration, the second side and the end 245 meet to form a corner of the parking block 210, and the end 245 has a smaller surface area than the second side. Like the configuration of FIG. 2A, this configuration enables routing the charging cord through the parking block, and from one end 245 of the parking block 210 to the other end 240 of the parking block 210, which shields the charging cord 205, and reduces the tripping hazard posed by an exposed charging cord laying on the ground.

FIG. 2C shows another configuration of the cord channel 220. In this configuration, the cord channel 220 still passes through, and is accessible from two exterior surfaces of the parking block 210, and like the configuration of FIG. 2A, the cord channel 220 is defined in two opposite sides of the parking block 210. Specifically, the cord channel 220 is again defined in, and accessible from, the first side 230 and the second side (not visible). For example, the entry port 215 is located in, and formed through, the first side 230, and the exit port 225 is located in, and formed through the second side (e.g., a car facing side of the parking block when in an installed state), that is on the opposite side of the top surface 235 than the first side 230. The exit port 225 is in the same section (e.g., outside of the middle ⅓ section) of the parking block 210, as discussed above with reference to FIG. 2A, but the entry port 215 is in the middle ⅓ section of the parking block 210. The entry port 215 and the exit port 225 are connected by a continuous void defining the cord channel 220. This configuration can be useful, for example, when the charging station 120 is located in a position such that the middle ⅓ section of the parking block 210 is closer to the charging station 120 than sections of the parking block 210 outside of the middle ⅓ section.

FIG. 2D shows another configuration of the cord channel 220. In this configuration, the cord channel 220 still passes through, and is accessible from two exterior surfaces of the parking block 210, and like the configuration of FIG. 2A, the cord channel 220 is defined in two opposite sides of the parking block 210. Specifically, the cord channel 220 is again defined in, and accessible from, the first side 230 and the second side (not visible). For example, the entry port 215 is located in, and formed through, the first side 230, and the exit port 225 is located in, and formed through the second side (e.g., a car facing side of the parking block when in an installed state), that is on the opposite side of the top surface 235 than the first side 230. In this configuration, both of the entry port 215 and the exit port 225 are located in the middle ⅓ section of the parking block 210. The entry port 215 and the exit port 225 are connected by a continuous void defining the cord channel 220. This configuration can be useful, for example, when the charging station 120 is located in a position such that the middle ⅓ section of the parking block 210 is closer to the charging station 120 than sections of the parking block 210 outside of the middle ⅓ section, and the charging cord 205 is to be routed under the EV 110, as illustrated by the dotted lines.

FIG. 2E shows another configuration of the cord channel 220. In this configuration, the cord channel 220 still passes through, and is accessible from two exterior surfaces of the parking block 210, and like the configuration of FIG. 2A, the cord channel 220 is defined in two opposite sides of the parking block 210. Specifically, the cord channel 220 is again defined in, and accessible from, the first side 230 and the second side (not visible). For example, the entry port 215 is located in, and formed through, the first side 230, and the exit port 225 is located in, and formed through the second side (e.g., a car facing side of the parking block when in an installed state), that is on the opposite side of the top surface 235 than the first side 230. In this configuration, the exit port 225 is located in the middle ⅓ section of the parking block 210, but the entry port 215 is located outside of the middle ⅓ section of the parking block 210. The entry port 215 and the exit port 225 are connected by a continuous void defining the cord channel 220. This configuration can be useful, for example, when the charging station 120 is located in a position such that a ⅓ section of the parking block 210 outside of the middle ⅓ section is closer to the charging station 120 than sections of the parking block 210 the middle ⅓ section, and the charging cord 205 is to be routed under the EV 110, as illustrated by the dotted lines.

FIG. 2F shows another configuration of the cord channel 220. In this configuration, the cord channel 220 still passes through, and is accessible from two exterior surfaces of the parking block 210, but rather than being defined in two opposite sides of the parking block 210, the cord channel 220 is defined in, and accessible from, the end 245 and the second side (not visible). For example, the entry port 215 is located in the end 245, and the exit port 225 is in the middle ⅓ section of the parking block 210. The end 245 has a smaller surface area than the second side, a corner of the parking block 210 is defined by the end 245 and the second side. The entry port 215 and the exit port 225 are connected by a continuous void defining the cord channel 220. This configuration can be useful, for example, when the charging station 120 is located in a position such that the end 245 of the parking block 210 is closest to the charging station 120, and the charging cord 205 is to be routed under the EV 110 (e.g., in a middle section of a parking space), as illustrated by the dotted lines.

FIG. 2G is a side view of the parking block 210 showing the exit port 225 located outside of the middle ⅓ section of the parking block 210. In this configuration, the exit port 225 of the cord channel 220 is formed in, and accessible from, the second side 250. FIG. 2G also shows how the cord channel 220 extends from the exit port 225 to the entry port 215, which is formed in the end 245 of the parking block 210. The textured fill used to depict the cord channel 220 in these figures indicates that the cord channel 220 is formed within the body of the parking block 210 rather than the surface being viewed.

FIG. 2H is a top view of the parking block 210, which shows how the cord channel 220, as depicted in FIG. 2G is formed through the body of the parking block 210. More specifically, FIG. 2G is looking at the cord channel 220 through the top surface 235 and shows how the cord channel is formed from the entry port 215 at the end 245 to the exit port 225. In this configuration, the void defining the cord channel is created down a middle portion of the parking block 210, and then has a 90 degree turn toward the second side 250. Of course, angles other than a single 90-degree angle could be used (e.g., 45 degrees). Also, the cord channel 220 could be curved, rather than angled. Further, the cord channel could be configured to accommodate flat cords, as discussed with reference to FIGS. 3C and 3D.

FIGS. 2I-2K are different views of an example cord channel 220 as configured in FIG. 2C. In these figures, the entry port 215 is located in the middle ⅓ section of the parking block 210, and the exit port 225 is located outside of the middle ⅓ section of the parking block 210. FIG. 2I is a side view of the parking block with the first side 230 shown. The entry port 215 is shown as being formed through the side 230, and the cord channel 220 is formed by a void that extends through the body of the parking block 210 from the entry port 215 to the exit port 225, which is formed in the second side. FIG. 2J is an opposite side view of the parking block 210 with the second side 250 showing. The exit port 225 is shown as being formed through the side 250, and FIG. 2J shows the cord channel 220 as a void that extends through the body of the parking block 210 from the entry port 215 to the exit port 225. FIG. 2K is a top view of the parking block 210 showing the path of the cord channel 225 within the body of the parking block 210 and between the entry port 215 and the exit port 225.

FIG. 4A is an illustration of parking blocks 402, 404, and 406 that are interconnected by electrical conductors 408 and 410. The parking blocks 402, 404, and 406 can be similar to the parking block 210 discussed above. For example, the parking blocks 402, 404, and 406 can have cord channels 412 defined though their respective bodies, thereby allowing cords (e.g., conductors) to be routed through the parking blocks 402, 404, and 406.

In some implementations, the conductors 408 and 410 connecting the parking blocks 402, 404, and 406 can be a single continuous conductor that passes through each of the parking blocks 402, 404, and 406. In these implementations, the conductors can carry power, such as power from the EV charging station 120 to multiple different electric vehicles. For example, the parking block 402 can include a hardware interface to connect to the EV charging station 120. The hardware interface can be, for example, a wire harness or plug that enables a power cord 414, or anther conductor, to be electrically connected to a conductor segment located in the cord channel 412 of the parking block 402. The wire harness can be located at the end of the parking block 402 or at other locations, e.g., various locations of the entry port discussed above.

The conductor 408 electrically connects the conductor segment within the parking block 402 to another conductor segment that is located in the parking block 404 (e.g., in the cord channel 412), such that once the parking block 402 is connected to the EV charging station 120, or another power source, the parking block 404 is also connected to the EV charging station 120. Similarly, the conductor 410 electrically connects the conductor segment that is located in the parking block 404 (e.g., in the cord channel 412) to yet another conductor segment that is located in the parking block 406. As such, when the parking block 402 is connected to the EV charging station 120, or another power source, the parking block 406 is also connected to the EV charging station 120. In this way the interconnected parking blocks create a chain of power blocks that provide access to the power supplied by the EV charging station 120.

For example, as discussed above, each of the parking blocks 402, 404, and 406 can have exit ports, similar to those discussed above, formed in an exterior surface of the parking block, and charging cords having a charging port connected at the end can be connected to the conductor segments in the parking blocks through the exit ports. Alternatively, or additionally, the exit ports can have a wire harness, or another hardware interface, that enables a charging cable to be attached to the exit port. In this way, the charging cable can be connected to the power of the EV charging station 120 that is passing through conductors located within the parking blocks 402, 404, and 406.

In some implementations, the parking blocks 402, 404, and 406 can be manufactured as a pre-fabricated (e.g., hardwired) set of parking blocks, where the set of parking blocks includes two or more parking blocks that are connected to each other in a pre-fabricated manner. For example, a single continuous conductor (or multiple pre-connected conductors) can be used to connect the parking blocks 402, 404, and 406 in the manner shown by FIGS. 4A-4C. More specifically, the single continuous conductor (or multiple pre-connected conductors) can pass through the cord channels 412 of each of the parking blocks 402, 404, and 406, and connect these parking blocks in a manner similar to the conductors 408 and 410.

In some implementations, the parking blocks 402, 404, and 406 can be connectorized, such that the interconnection (e.g., electrical and/or physical interconnection) between the parking blocks 402, 404, and 406 can be made after fabrication of the parking blocks 402, 404, and 406, such as when the parking blocks 402, 404, and 406 are installed. For example, each of the parking blocks 402, 404, and 406 can include connectors (e.g., wire harnesses or other appropriate connectors) at their respective entry ports and exit ports, and the conductors 408 and 410 can each have mating connectors that are configured to mate to (e.g., connect, secure, and/or lock onto) the connectors at the entry and exit ports. In this example, the parking blocks 402, 404, and 406 can be placed at their respective installation locations, and then the conductors 408 and 410 can be connected to the connectors at the entry and exit ports to connect the parking blocks 402, 404, and 406 in the manner shown in FIGS. 4A-4C.

In some implementations, fewer than all of the entry ports or exit ports (including zero entry ports or exit ports) can have connectors. In these implementations, one type of port (e.g., entry port) can be connectorized, and the other type of port (e.g., exit port) can be pre-fabricated to have the conductor (e.g., 408) extending from the parking block. In these implementations, the conductor (e.g., 408) extending from the exit port of a parking block (e.g., 402) can have a mating connector attached at the end so that the conductor (e.g., 408) can be connected to the connector at the entry port of another parking block (e.g., 404). Of course, the entry port rather than the exit port could be pre-fabricated with the conductor extending from the parking block with the exit port being connectorized.

Lengths of the conductors 408 and 410, or other connections between the parking blocks, can be selected to enable the parking blocks to be stacked, or otherwise aligned in a stacked fashion. For example, as shown in FIG. 4C, the parking blocks 404 and 406 are both stacked on top of the parking block 402. As seen, the interconnections between the parking blocks created by the conductors 408 and 410 remain intact even after the parking blocks are stacked. This enables the parking blocks 402, 404, and 406 to simply be unstacked at an installation location, without requiring any electrical work, or modification of the parking blocks. As used herein, creating a stacked formation does not necessarily require placing the parking blocks on top of each other. Rather, the parking blocks could be in a stacked formation by being set side by side in a similar manner as shown in FIG. 4C, thereby creating a “stacked” formation, although the blocks are only supporting their own weight.

In some implementations, the lengths of the conductors 408 and 410 can be chosen based on the sizes of the parking spaces in which the parking blocks 402, 404, and 406 will be placed and/or the lengths of the parking blocks 402, 404, and 406. For example, assume that the parking spaces in which the parking blocks 420, 404, and 406 will be installed are 9 feet wide, and that each of the parking blocks is 7 feet long. In this example, there will be 4 feet of space between each installed parking block, such that the length of each of conductors 408 and 410 can be 4 feet.

In some implementations, the segments of conductors (e.g., electrical conductors) that are within the cord channels 412 of the parking blocks 402, 404, and 406 are embedded in the parking block while the parking block is manufactured. For example, prior to the hardening of the parking block, the segments of conductors (or precast voids) can be inserted into each of the parking blocks 402, 404, and 406. As the material used to create the parking blocks 402, 404, and 406 hardens, the cord channels 412 are defined by the electrical conductors, and the segments of conductors are fixed in place. For example, the parking blocks can be made of concrete, plastic, rubber, or another appropriate material, and before the selected material hardens, the electrical conductors can be inserted within a perimeter of the parking block body and left in place until the selected material hardens.

In some implementations, the segments of conductors are added to the parking blocks 402, 404, and 406 after the parking blocks have already hardened. In these implementations, the cord channels 412 can be formed by core drilling, chasing, saw cutting, or otherwise creating a void in the hardened parking block through which conductors can be routed.

In some implementations, the conductors 408 and 410 are ribbon type (e.g., flat) conductors that are rectangular or otherwise flat or angled compared to round conductors that are traditionally used for EV charging applications. Using ribbon type conductors to interconnect the parking blocks 402, 404, and 406 reduces the profile (e.g., height) of the conductors 408 and 410 from the ground, which reduces the tripping hazard posed by the conductors 408 and 410. FIG. 4B shows a top view of the parking blocks 402, 404, and 406 as interconnected using ribbon type conductors as the conductors 408 and 410. As shown, the cord channels 412 in each of the parking blocks 402, 404, and 406 are rectangular in shape to accommodate the ribbon type conductors.

In some implementations, the interconnection between the parking blocks 402, 404, and 406 can include a reinforcement member that prevents excess tension from being exerted on the conductors 408 and 410. For example, metal cabling, chains, or other devices that restrict the movement of the parking blocks can be attached between the parking blocks to prevent damage to the conductors 408 and 410 prior to installation of the parking blocks 402, 404, and 408. The reinforcement members can be removed at, or after, installation, since the parking blocks 402, 404, and 406 will be fixed in place using bolts and/or adhesive.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A parking block, comprising:
a top surface; and
a bottom surface, wherein the bottom surface is configured to be closer to the ground than the top surface when the parking block is in an installed state, wherein:
the parking block has a cord channel defined at a location within the parking block that is between the top surface and the bottom surface; and
the cord channel is a void configured to accept a cord that connects an electric vehicle (EV) charger to an EV charging port configured to physically connect to an EV.

2. The parking block of claim 1, wherein the cord channel is accessible through the bottom surface of the parking block.

3. The parking block of claim 1, wherein the cord channel is accessible from an exterior surface of the parking block.

4. The parking block of claim 3, wherein the cord channel is accessible from two exterior surfaces of the parking block.

5. The parking block of claim 4, wherein:
the two exterior surfaces including a first exterior surface and a second exterior surface; and
the cord channel is defined in and accessible from each of the first exterior surface and the second exterior surface; and
the cord channel is a continuous void that extends between and through the first exterior surface and the second exterior surface.

6. The parking block of claim 5, wherein the first exterior surface and the second exterior surface meet to form a corner of the parking block.

7. The parking block of claim 5, wherein:
the first exterior surface is an end surface of the parking block having a smaller surface area than the second exterior surface; and
the cord channel is formed through the second exterior surface in a middle one-third section of the second exterior surface.

8. The parking block of claim 5, wherein:
the first exterior surface is an end surface of the parking block having a smaller surface area than the second exterior surface; and
the cord channel is formed through the second exterior surface outside of a middle one-third section of the second exterior surface.

9. The parking block of claim 5, wherein:
the first exterior surface is on an opposite side of the bottom surface than the second exterior surface; and
a first distance from an end surface of the parking block at which the cord channel passes through a first plane of the first exterior surface differs from a second distance from the end surface of the parking block at which the cord channel passes through a plane of the second exterior surface.

10. The parking block of claim 1, wherein a perimeter of the cord channel is angled.

11. The parking block of claim 10, wherein the perimeter of the cord channel is rectangular.

12. The parking block of claim 1, wherein a perimeter of the cord channel is arced or rounded.

13. The parking block of claim 1, further comprising:
electrical conductors routed through the cord channel; and
a wire harness connector located at one or more ends of the cord channel.

14. The parking block of claim 13, further comprising:
a connection to a second parking block, wherein the connection to the second parking block has a length that enables the parking block to be aligned with the second parking block in a stacked formation.

15. The parking block of claim 13, wherein:
the electrical connectors are embedded in the parking block prior to hardening of the parking block; and
the cord channel is defined by the electrical conductors as the parking block hardens.

16. The parking block of claim 15, wherein:
the parking block is one or more of concrete, plastic, or rubber; and
the cord channel is defined by the electrical conductors that are located within a perimeter of the parking block as the concrete, plastic, or rubber cures.

17. The parking block of claim 13, wherein the wire harness connector is located at one or more of an entry port or an exit port of the cord channel of the parking block.

18. The parking block of claim 17, wherein the wire harness connector is located at both of the entry port and the exit port of the cord channel of the parking block.

19. The parking block of claim 14, wherein the connection to the parking block is a pre-fabricated connection between the parking block and the second parking block in a hardwired manner.

20. The parking block of claim 14, wherein the connection to the second parking block is connectorized in a manner that enables the connection to the second parking block to be made after the parking block is placed into an installation location.
